(19) United States
(12) Patent Application Publication
(10) Pub. No.: US 2024/0181540 A1
(43) Pub. Date: Jun. 6, 2024

(54) TOOL HOLDER, DEVICE AND METHOD FOR CLAMPING AND UNCLAMPING TOOLS

(71) Applicant: Bilz Werkzeugfabrik GmbH & Co. KG, Ostfildern (DE)

(72) Inventors: Daniel BUEHLER, Esslingen am Neckar (DE); Adrian RETZBACH, Riederich (DE); Michael VOSS, Leonberg (DE)

(21) Appl. No.: 18/442,282

(22) Filed: Feb. 15, 2024

Related U.S. Application Data
(63) Continuation-in-part of application No. PCT/EP2022/062673, filed on May 10, 2022.

(30) Foreign Application Priority Data
Aug. 19, 2021 (DE) 10 2021 121 569.2

(51) Int. Cl. B23B 31/20; B23B 31/117

(52) U.S. Cl. CPC B23B 31/201; B23B 31/1179

(57) ABSTRACT

A device for clamping and unclamping tools in a collet comprises a tool holder, a collet and a movable tensioner. The tool holder has a machine side and a tool side that is configured to accommodate a tool shank of a tool. The collet is arranged for clamping the tool shank inside the collet, the collet having a conical outer surface, which rests against a correspondingly shaped inner surface of the tool holder. The tensioner is configured to effect an axial movement of the collet with respect to the tool holder when the tool holder is thermally expanded, for clamping and unclamping the collet with the tool shank therein. The tensioner is arranged inside the tool holder on the machine side of the collet. A method is used to clamp tools in a collet of a tool holder.

### CROSS-REFERENCE TO RELATED APPLICATIONS

This application is a continuation-in-part of international patent application PCT/EP2022/062673, filed on May 10, 2022, and designating the U.S., which international patent application has been published in German language and claims priority to national German patent application 10 2021 121 569.2, filed on Aug. 19, 2021. The entire contents of these priority applications are incorporated herein by reference.

### BACKGROUND

The present disclosure relates to a device for clamping and unclamping tools in a tool holder, having a collet that has a conical outer surface that rests against a correspondingly shaped inner surface of a tool holder, and a tensioner that is axially movable in the tool holder for clamping and unclamping the collet.

The present disclosure also relates to a method for clamping and unclamping work pieces in a collet. The present disclosure further relates to a tool holder having a collet for clamping tools therein.

Collets have been used for decades in the art to clamp tools with high clamping force and high precision. With smaller diameters, however, the clamping force is naturally relatively limited.

Regularly, the general goal is to generate clamping forces that are preferably as high as possible.

European patent EP 2 305 407 B1 discloses a collet chuck with a clamping nut, which can be screwed onto the outer end of the collet chuck from the outside. To clamp a tool, the collet is first preloaded by tightening the collet nut with a first tightening torque, then the collet nut is tempered so that the collet nut has a higher temperature than the collet chuck or the collet. The clamping nut and the collet chuck are then screwed together with a second, higher tightening torque. In this way, overall a higher clamping force than with conventional collets is to be achieved.

The disadvantage of this design is that it is hardly possible to clamp a tool with a reproducible clamping force. During the first heating step, the collet is heated together with the externally mounted clamping nut, after which the heating unit must first be removed before clamping with the first tightening torque can take place. Only then is it heated again and then tightened with the second higher tightening torque. Automation is also hardly possible with such an arrangement.

Furthermore, conventional collets are known, which can be operated by means of a tensioner (see national German patent application DE 39 38 689 A1).

In view of this, it is an object of the present disclosure to present a device for clamping and unclamping tools in a collet, by means of which a clamping force that is preferably as high as possible can be achieved.

It is a further object of the present disclosure to present a device for clamping and unclamping tools that enables a highly reproducible clamping force.

It is a further object of the present disclosure to present a device for clamping and unclamping tools that is suitable for an automated operation, preferably with a high degree of automation.

It is a further object of the present disclosure to present a device for clamping and unclamping tools that enables a high level of concentricity.

It is a further object of the present disclosure to present a corresponding tool holder for clamping and unclamping tools therein.

It is a further object of the present disclosure to present a corresponding method for clamping and unclamping tools in a collet.

### SUMMARY

According to a first aspect, these and other objects are achieved by a device for clamping and unclamping tools in a collet, comprising a tool holder having a machine side and a tool side that is configured to accommodate a tool shank of a tool, a collet that is arranged for clamping the tool shank inside the collet, the collet having a conical outer surface, which rests against a correspondingly shaped inner surface of the tool holder, and a movable tensioner that is configured to effect an axial movement of the collet relative to the tool holder when the tool holder is thermally expanded, for clamping and unclamping the collet with the tool shank therein, wherein the tensioner is arranged inside the tool holder on the machine side of the collet.

In certain aspects of the present disclosure, high clamping forces can be achieved by combining thermal (shrink-fit) clamping induced by the heating of the tool holder with the heating device with friction-based clamping induced by the axial movement of the collet induced by the tensioner. As the tool holder and the collet have conical mating surfaces, in the thermally expanded state of the tool holder, the collet with the tool shank therein may be further urged against the corresponding (expanded) conical surfaces in the axial direction. When the heating is stopped and the tool holder is cooled down, shrinking-related forces significantly superimpose friction-related forces. This has the effect that, with relatively small (mechanical) actuation forces, huge clamping forces can be achieved, at least in certain embodiments.

In an exemplary embodiment, the device comprises a heating unit for heating the tool holder in the region of the collet. In an exemplary embodiment, the heating unit is arranged as an inductive heating unit having an induction coil, wherein the induction coil is arranged to be positioned concentrically to the tool holder in the region of the collet for heating the tool holder in the region of the collet. In an exemplary embodiment, the device comprises an actuator that is arranged as a rotary drive that is configured to rotate the tensioner, wherein a threaded connection is provided between the tensioner and the tool holder for converting a rotary movement of the actuator into an axial movement of the tensioner relative to the tool holder.

In an exemplary embodiment, the actuator is coupled to the tensioner via a rotary shaft that is configured to engage the tensioner through a machine side of the tool holder. In an exemplary embodiment, an axial form fit is provided between the tensioner and the collet that effects the axial movement of the collet when the tensioner is axially moved. In an exemplary embodiment, a threaded connection is formed between the tensioner and the collet that effects the axial movement of the collet when the tensioner is rotated.

In an exemplary embodiment, the collet is held non-rotatably in the tool holder, wherein a threaded connection is formed between the tensioner and the tool holder, and wherein the threaded connection between the tensioner and the tool holder and the threaded connection between the tensioner and the collet have different pitches to form a differential thread.

In an exemplary embodiment, the device comprises a holder that is arranged to receive the tool holder in a rotationally fixed manner. In an exemplary embodiment, the device comprises a control unit that is configured to coordinate the heating of the tool holder and the collet with the movement of the tensioner and the collet for clamping or unclamping the tool in the collet.

In an exemplary embodiment, a coefficient of static friction between the tool holder and the collet is lower than a coefficient of static friction between the collet and the tool shank. In an exemplary embodiment, the collet is held interchangeably inside the tool holder. In an exemplary embodiment, a central coolant supply is provided through the machine side of the tool holder via the tensioner into the collet. In an exemplary embodiment, a projection projecting towards the tool shank is formed inside the collet, which enables an axial form fit with the tool shank in a clamped state of the tool shank, and wherein the tool shank is releasable from the projection only when the collet is in a released state. In an exemplary embodiment, the tensioner is axially guided within the tool holder and comprises a clamping surface facing the collet, which cooperates with a corresponding surface of the collet facing the tensioner to clamp the collet.

According to another aspect, the above and other objects are achieved by a device for clamping tools in a collet of a tool holder, comprising a holder having a flange that is configured to accommodate a machine-side section of a tool holder, a heating unit for heating the tool holder in a region where a collet is accommodated in the interior of the tool holder, and an actuator that is configured to operate a tensioner inside the tool holder that is coupled to the collet to axially move the collet within the tool holder, when the tool holder is thermally expanded through heating with the heating unit.

In an exemplary embodiment, the device comprises a control unit that is operatively coupled to the heating unit and the actuator, wherein the control unit is configured to coordinate the heating of the tool holder with a movement of the tensioner relative to the collet for clamping or unclamping tools, wherein, for a clamping action, the collet is axially moved in a first direction into a clamped state to clamp a tool shaft when the tool holder is thermally expanded, and wherein, for an unclamping action, the collet is moved in a second direction that is opposite to the first direction into a loosening state when the tool holder is thermally expanded.

According to another aspect, the above and other objects are achieved by a tool holder for a tool having a tool shank, the tool holder comprising a machine-side portion having a tapered mounting shaft, a tool-side portion that is configured to accommodate a tool shank of a tool, an outer flange between the machine-side portion and the tool-side portion, a collet arranged in the tool-side portion, wherein the collet has a conical outer surface, which is adapted to a correspondingly shaped inner surface of the tool holder, and wherein the collet is configured to accommodate and clamp the tool shank inside the collet upon a thermal expansion of the tool-side portion of the tool holder that is coordinated with an axial movement of the collet inside the thermally expanded tool-side portion, and a tensioner that is movably arranged in the tool holder and operatively coupled with the collet to effect the axial movement of the collet relative to the tool holder.

In an exemplary embodiment of the tool holder, in a clamped state with the collet nested in the tool-side portion of the tool holder and the tool shank nested in the collet, an increased effective clamping force is present due to a combination of the axial movement of the collet in an expanded state of the tool-side portion of the tool holder and a shrinking of the tool-side portion of the tool holder.

According to another aspect, the above and other objects are achieved by a method for clamping tools in a collet of a tool holder, the method comprising the following steps:
providing a collet that has a machine side and a tool side, and having inserted therein a collet, the collet having a conical outer surface in a correspondingly shaped cavity of the tool holder;
coupling the collet with a tensioner for clamping or unclamping the collet,
wherein the tensioner is movable within the tool holder, and
wherein the tensioner is coupled to the collet on a machine side of the collet;
inserting a tool with a tool shank into a cavity that is formed by the collet;
heating the tool holder in the region of the collet; and
while the tool holder is thermally expanded due to the heating, moving the tensioner for clamping the collet with the tool shank therein.

According to another aspect, the above and other objects are achieved by a method for unclamping tools that are clamped in a collet of a tool holder, the method comprising the following steps:
providing a collet that has a machine side and a tool side, and having inserted therein a collet, the collet having a conical outer surface in a correspondingly shaped cavity of the tool holder, the collet having inserted therein a tool with a tool shank that is inserted and clamped in a cavity that is formed by the collet,
wherein the collet is coupled with a tensioner for clamping or unclamping the collet,
wherein the tensioner is movable within the tool holder, and
wherein the tensioner is coupled to the collet on a machine side of the collet;
heating the tool holder in the region of the collet;
while the tool holder is thermally expanded due to the heating, moving the tensioner for unclamping the collet and the tool shank; and
removing the loosened tool shank from the collet and the tool holder.

According to another aspect, the above and other objects are achieved by a device for clamping and unclamping tools in a collet, comprising a collet, which has a conical outer surface, which rests against a correspondingly shaped inner surface of a tool holder, which has a machine side and a tool side, and an axially movable tensioner, which is configured to enable an axial movement for clamping and fixing the collet or for pulling out the collet when the tool holder is thermally expanded, wherein the tensioner is arranged inside the tool holder on the machine side of the collet.

According to another aspect, the above and other objects are achieved by a method for clamping and unclamping tools in a collet, the method comprising the following steps:
inserting a collet having a conical outer surface into a correspondingly shaped cavity of a tool holder that has a machine side and a tool side;
coupling the collet with a tensioner for clamping or unclamping the collet, which is axially movable within the tool holder, and which is arranged on the machine side;
inserting the tool with its shank into a cavity that is surrounded by the collet;
heating the tool holder in the region of the collet; and
axially moving the tensioner for clamping and fixing the collet or for pulling out the collet, while the tool holder is thermally expanded.

The tool holder can be thermally expanded, and the collet can be clamped in the thermally expanded state. That is, in accordance with the present disclosure, clamping tool shanks in a tool holder combines aspects of shrink-fit clamping and aspects of friction-based clamping with clamping collets. In the clamped state, the tool holder clamps the collet arranged therein, and the collet clamps the tool shank arranged therein.

During heating, the tool holder increases both its internal diameter and its length in the region of the collet and behind it. When the collet is brought into abutment with the tool holder and the tool shank by the tensioner by means of axial infeed, the forces resulting from the thermally initiated relative movement, namely from the radial thermal expansion and the axial movement, are superimposed during the subsequent cooling. This allows very high clamping forces to be applied to the tool shank, at least in certain embodiments, which are 2 to 4 times higher than the clamping forces of conventional shrink fit chucks.

Depending on the cone angle of the collet and the friction ratios between the tool shank and the collet, as well as between the collet and the tool holder, an axial tensile force on the tool results in an increase in the force of the radially acting clamping forces. With a good design, pull-out of the tool due to axial forces can therefore be reliably ruled out or at least shifted towards higher pull-out forces.

Furthermore, the axial movement of the collet against the inner cone of the tool holder fully compensates for tolerances in the shank diameter. The holding forces are independent of shank tolerances and manufacturing tolerances in the diameter.

This results in a high reproducibility of the clamping force. Automated or semi-automated actuation is also possible.

As the tensioner is located inside the tool holder on the tool side, heating ensures that the outer region of the tool holder heats up first together with the collet without affecting the tensioner or an actuation of the tensioner. The tensioner can be actuated at any time, even if the tool holder is inside an associated heating unit.

The combination of different materials, bodies, and friction contacts in the force flow between the machine-side holder and the tool shank may also have a positive effect on the damping properties of the tool holder system, at least in certain embodiments.

A heating unit is provided for heating, which is preferably an inductive heating unit.

With an inductive heating unit, considerably fast, targeted heating in the desired region can be achieved, at least in certain embodiments.

The application of the axial force between the tensioner and the collet can basically be force-controlled or travel-controlled.

According to a further embodiment, a positive-fit connection in the axial direction is provided between the tensioner and the collet.

This allows the collet to be pulled out for loosening, even if it is still stuck in the tool holder due to unfavorable friction conditions.

In certain embodiments, an actuator is provided that is configured to actuate the tensioner. According to a further embodiment, an actuator is provided for the movement of the tensioner.

Preferably, the actuator is arranged as a rotary drive, by means of which the tensioner can be rotated, wherein a threaded connection is provided between the tensioner and the tool holder for converting a rotary movement of the actuator into an axial movement of the tensioner.

In this way, the movement of the tensioner for clamping and/or unclamping the collet can be easily generated via a rotary movement using the actuator.

Instead of the combination of a thread in connection with an actuator as a rotary drive for the movement of the tensioner, it is conceivable to use an external tension/compression rod that is not a permanent part of the tool holder. Such a design is, for instance, feasible for very small cone angles in the range from −5° to +5°.

According to a further embodiment, a holder is provided, in which the tool holder can be fixed in a rotationally fixed manner. This prevents the tool holder from rotating when the actuator is driven.

According to a further embodiment, the actuator is arranged as a motor, which is coupled to the tensioner via a shaft, wherein a control unit is provided, which is configured to coordinate the heating of the tool holder and the collet with a movement of the tensioner relative to the collet for clamping or unclamping. In certain embodiments, the actuator actuates a shaft that is configured to engage the tensioner when the tool holder is placed in the flange portion of the holder.

In this way, the movement of the tensioner for clamping and/or unclamping the collet can be optimally coordinated with the thermal expansion of the tool holder in the region of the collet. In this way, optimum holding forces can be generated and secure unclamping can be ensured at the same time.

According to a further embodiment, the cone angle of the collet is in the range of 0.01° to 45°, preferably in the range of 0.1° to 10°. In certain embodiments, a cone having a cone angle is formed between the collet and the inner surface of the tool holder, the cone having a tip pointing towards the tool side.

It has been observed that an optimum design of the collet with high clamping forces can be achieved with such a cone angle.

Preferably, the coefficient of static friction between the tool holder and the collet is lower than the coefficient of static friction between the collet and the tool shank.

With axial pull-out forces, this results in an increase in the radial clamping force acting on the tool shank.

According to a further embodiment, the cone angle of the collet is in the range of −0.01° to −20°, preferably in the range of −0.1° to −10°. In certain embodiments, a cone having a cone angle is formed between the collet and the inner surface of the tool holder, the cone having a tip pointing towards the machine side.

In certain embodiments, the collet is connected to the tensioner via a threaded connection. Hence, when the collet is mounted to be rotationally fixed but axially movable in the tool holder, a rotation of the tensioner would axially move the collet, due to the threaded connection between the collet and the tensioner

In certain embodiments, the combination of the thermal expansion of the tool holder and the axial movement of the collet can also be achieved with a negative cone angle. In this case, the collet is connected to the tensioner via a threaded connection to ensure that it can be fixed in the tool holder.

According to a further embodiment, the threaded connection between the collet and the tensioner has a pitch that differs from the pitch of the threaded connection between the tensioner and the tool holder. In this case, the collet is preferably nonrotatably mounted on the tool holder.

A differential thread that is formed in combination in this way makes it possible to achieve a certain fine-tuning of the collet tension, at least in certain embodiments. As the tensioner is rotated, the collet is moved at the same time.

According to a further embodiment, the tool holder is configured to accommodate collets with different internal diameters, wherein the collet is interchangeably accommodated in the tool holder.

In this way, one tool holder can be used for collets with different tool diameters.

According to a further embodiment, damping elements, for instance elastomer elements that are thermally stable up to at least 100° C., are provided between the tensioner and the tool holder. This could involve NBR (acrylonitrile butadiene rubber), for example.

In this way, vibrations during the use of a tool clamped in the collet can be counteracted.

In certain embodiments, a stop surface for the tensioner is provided in the tool holder for limiting an axial travel of the tensioner and the cone. According to a further embodiment, a stop surface for the tensioner is provided on the machine side in the tool holder to limit the axial travel.

In this way, defined conditions can be achieved to limit the opening and/or closing travel.

According to a further embodiment, a central coolant supply is provided through the tool holder via the tensioner into the collet.

In this way, a coolant flow through the machine side of the tool holder can be achieved.

A flange can be provided in the tool holder, on which a coolant supply is held in the form of a tubular extension and which has a stop surface for the tensioner. Hence, a synergistic effect is provided, at least in certain embodiments.

According to a further embodiment, the heating unit is arranged as an inductive heater with an induction coil, which can be positioned concentrically to the tool holder in the region of the collet, wherein preferably a pole disk made of a soft magnetic, electrically non-conductive material can be positioned on the outer end of the tool holder.

This ensures simple, easily controllable heating for thermal expansion, specifically in the region of the collet.

According to a further embodiment, a projecting projection is provided on the collet in the direction towards the tool shank, which allows a positive fit with the tool shank, for instance with a Weldon surface according to DIN 1835 B (German Institute for Standardization), and which can only be removed from the tool shank when the collet is released.

This provides additional safety against the tool shank being pulled out of the collet. The positive locking can be overcome when the collet is loosened if it is widened sufficiently.

According to a further embodiment, the tensioner is made of a material with a higher density than steel, for instance an alloy containing osmium and/or tungsten.

In this way, the resonance frequency of the tool holder system can be specifically shifted by combining materials of different densities.

According to a further embodiment, the tensioner is guided within the tool holder in the axial direction and has a clamping surface facing the collet, which interacts with a flat surface facing the tensioner or with a conical surface of the collet.

By supporting the tensioner on a flat surface of the collet, forces in the transverse direction are avoided, which reduces adverse influences that can be generated by a threaded connection of the tensioner. If the tensioner interacts with a conical surface of the collet, centering is supported. In both cases, this results in improved concentricity.

According to a further embodiment, the tensioner is guided within the tool holder in the axial direction and is coupled to the collet via an at least partially crowned or spherical surface.

By coupling the tensioner to the collet via an at least partially crowned or spherical surface, transverse forces are widely eliminated, resulting in further improved concentricity.

According to a further embodiment, a control unit is provided, which is coupled to the actuator and to the heating unit in order to coordinate the actuation of the actuator and the activation of the heating unit with one another.

The use of such a control unit enables an optimized process for clamping and unclamping tools. This also results in improved reproducibility compared to manual operation, and an operating time is ensured that is reduced to the absolutely necessary time.

It is to be understood that the previously mentioned features and those mentioned in the following may not only be used in the indicated combination, but also in other combinations or as isolated features without leaving the spirit and scope of the present disclosure.

### BRIEF DESCRIPTION OF THE DRAWINGS

Further features and advantages of the present disclosure will be apparent from the following description and explanation of several preferred embodiments with reference to the drawings, wherein:

FIG. 1 shows a perspective view of a first embodiment of a tool holder with a collet accommodated therein;

FIG. 2 shows a longitudinal section through the tool holder according to FIG. 1;

FIG. 3 shows a device having a tool holder and a collet, which is accommodated in a holder, an actuator for moving the tensioner, and a heating unit for a thermal expansion of the tool holder in the region of the collet;

FIG. 4 shows a tool holder having a collet as shown in FIG. 2, which is additionally provided with elastomer elements between the tensioner and the tool holder;

FIG. 5 shows a section through the tool holder according to FIG. 4 along the line V-V;

FIG. 6 shows a slightly modified version of the tool holder according to FIG. 4;

FIG. 7 shows a longitudinal section through a tool holder having a collet, wherein a negative cone angle is provided;

FIG. 8 shows a simplified block diagram illustrating an exemplary embodiment of a method for clamping tools in a collet of a tool holder; and

FIG. 9 shows a simplified block diagram illustrating an exemplary embodiment of a method for unclamping tools from a collet of a tool holder.

### EMBODIMENTS

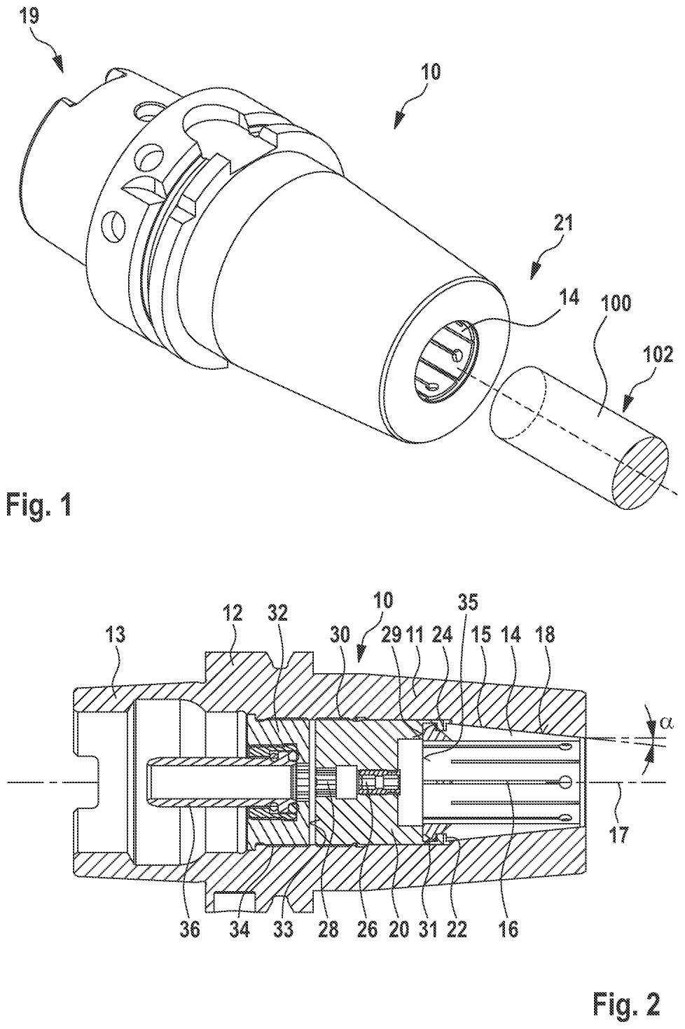

A tool holder having a collet is shown in perspective in FIG. 1 and is overall designated by numeral 10. At the front end, a collet 14 held therein is recognizable. FIG. 1 also shows a tool 100 (in a partial view) having a shank 102 that can be inserted in the tool holder 10 for clamping and fixing the tool 100 there in the collet 14.

FIG. 2 shows a longitudinal section through the tool holder 10 with the collet 14. Externally, the tool holder 10 is of the usual HSK (hollow shank taper) type of a shrink chuck or the like, with a flange 12 in an adjoining machine-side portion 13 and with an outer portion 11, which is tapered in the front region. The outer portion 11 faces away from the machine-side portion 13. The collet 14 is accommodated in the front region of the outer portion 11.

The collet 14 has an outer surface 15 that tapers outwards in the shape of a cone and rests against a correspondingly shaped inner surface 18 of the tool holder 10. The cone angle α (alpha) is the angle between the inner surface 18 and a line parallel to the longitudinal axis 17 of the tool holder 10, as shown in FIG. 2. In the illustrated case, the cone angle is approximately 3 to 4°. As usual, the collet 14 is provided with alternating longitudinal slots 16 from both ends. An axially movable tensioner 20, which is directly connected to the collet 14, and which is coupled to the collet 14 via a positive connection in the region of the axial end of the collet 14, is used for clamping the collet 14.

The positive fit is formed by an annular web 24, which engages with play in a correspondingly shaped annular groove 22 of the collet 14. In this way, axial movement of the tensioner for unclamping the collet 14 ensures that the collet 14 can be retracted even if it is stuck in the tool holder 10 due to unfavorable friction conditions. The substantially cylindrically shaped tensioner 20 is coupled to the tool holder 10 at the machine-side end via a threaded connection 30.

Furthermore, a flange 32 is screwed into the tool holder 10 at a distance from the tensioner 20 via a threaded connection 34. A tubular extension 36 for a coolant supply is accommodated in the flange 32, which is guided via a central coolant channel 26 to the collet 14 in order to ensure effective cooling during the operation of a tool clamped in the collet 14.

When moving towards the collet 14, the tensioner 20 can act with a clamping surface 35 on either a facing flat contact surface 29 of the collet 14 or a conical surface 31 of the collet 14. In both cases, improved concentricity is promoted.

Alternatively, it is conceivable to couple the tensioner 20 to the collet 14 via an at least partially crowned or spherical surface (not shown). This can achieve a further improvement in concentricity.

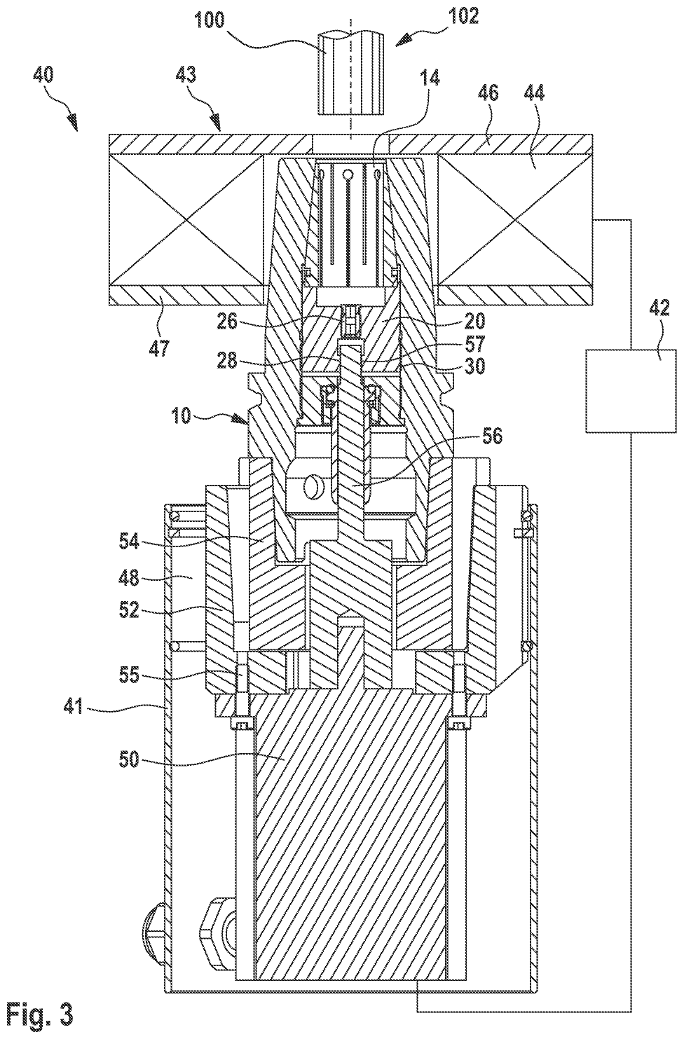

A polygonal opening 28 is provided at the machine-side end of the tensioner 20, into which a correspondingly shaped tool can engage for axial movement of the tensioner 20 for clamping and/or unclamping the collet 14, in order to be able to move the tensioner 20 axially by rotation by means of the threaded connection 30, as explained in more detail below with reference to FIG. 3.

While FIG. 2 shows the tool holder with collet 14 in the state of use, in which a tool 100 is normally clamped with its shank 102 inside the collet 14 (not shown), FIG. 3 shows the tool holder 10 with the collet 14, which is additionally held in a holder 48 and is coupled by means of a motor-driven actuator 50 for the axial movement of the tensioner 20 and is additionally provided with a heating unit 43.

The entire device formed in this way is designated by the numeral 40 and may also be referred to as clamping/unclamping device. Components of the device 40 may be arranged in a housing 41. The tool holder 10 with the collet 14 is non-rotatably received in the holder 48. An actuator 50 in the form of a rotary drive is provided in the holder 48, which actuator 50 is mounted to a flange 52 by means of screw connections 55 and is provided with an intermediate flange 54, into which the tool holder 10 can be inserted from above in a non-rotatable manner. The actuator 50 drives a shaft 56, the outer end of which is provided with a polygon 57, which engages positively in the correspondingly shaped inner polygon 28 of the tensioner 20. Since the tensioner 20 is held rotatably in the tool holder 10 via the threaded connection 30, a rotary movement of the actuator 50 can thus be converted into an axial movement of the tensioner 20 via the shaft 56.

In the region of the collet 14, the tool holder 10 is surrounded by an inductive heating unit, which is overall designated by numeral 43. The heating unit 43 preferably has an induction coil 44, which encloses a cavity, in which the tool holder 10 is accommodated in the region of the collet 14. A pole disk 46 made of an electrically non-conductive but magnetically conductive material, such as ferrite, is placed on the upper end of the induction coil 44 in order to close the magnetic field at the upper end when the induction coil 44 is activated. Furthermore, a pole disk 47 is preferably also provided at the lower end of the induction coil 44, via which the magnetic flux is closed. The magnetic field is concentrated on the region of the tool holder 10 with the collet 14 by the pole disks 46, 47, so that unnecessary and harmful heating of the remaining region of the tool holder 10 is largely avoided. The induction coil 44 is coupled to an automated control unit 42, which is also used to control the actuator 50.

If a tool 100 is now to be clamped with its tool shank 102 inside the collet 14, it is first inserted into the collet 14 with its tool shank from above. In this state, the tensioner 20 is still retracted axially so that the collet 14 is not under tension. For clamping, the induction coil 44 is now activated via the control unit 42 so that the tool holder 10 is heated together with the collet 14 via the induced short-circuit current. If the collet is sufficiently thermally expanded, the axial movement of the tensioner 20 takes place via the rotary drive of the actuator 50 in order to clamp the collet 14.

The movement of the actuator 50 is stopped by the control unit 42, and at the same time, the current flow through the induction coil 44 is terminated in order to initiate cooling, which may be supported by a cooling fan or the like.

By means of the control unit 42, the movement of the actuator 50 can be optimally coordinated with the current flow through the induction coil 44 in order to ensure a high reproducibility of the clamping force and also to reduce the time to the minimum that is necessary to ensure an optimized clamping and/or unclamping process.

During heating, the tool holder 10 increases both its inner diameter and its length in the region of the collet 14 and behind it. During the subsequent cooling process, the forces resulting from the thermally injected relative movement, the radial thermal expansion and the axial movement of the screw connection are superimposed. In this way, very high clamping forces on the tool shank can be achieved. Depending on the cone angle α of the collet 14 and the friction ratios between the tool shank and the collet 14, as well as between the collet 14 and the tool holder 10, an axial tensile force on the tool results in an increase in the radially acting clamping forces. This reliably prevents the tool from being pulled out.

In principle, instead of a fully automatically controlled movement of the tensioner by means of the actuator, a partial or fully manual activation of the tensioner is of course also conceivable.

For later removal of the tool, the outer contour of the tool holder 10 is heated in the region of the collet 14, and the backward movement of the tensioner 20 is initiated at the same time. The axial form fit 22, 24 with a degree of freedom in the rotation between the tensioner 20 and the collet 10 ensures the demolding of the collet 14 from the inner cone of the tool holder 10.

It is conceivable that a higher pull-out force is required to release the collet 14 than the one that must be applied during the clamping process due to the simultaneous co-heating of the collet. This should be taken into account in the design.

During unclamping, the axial travel of the clamping unit is limited on the rear side by a stop surface 33, which can be part of the coolant transfer, namely formed on the flange 32 (see FIG. 2).

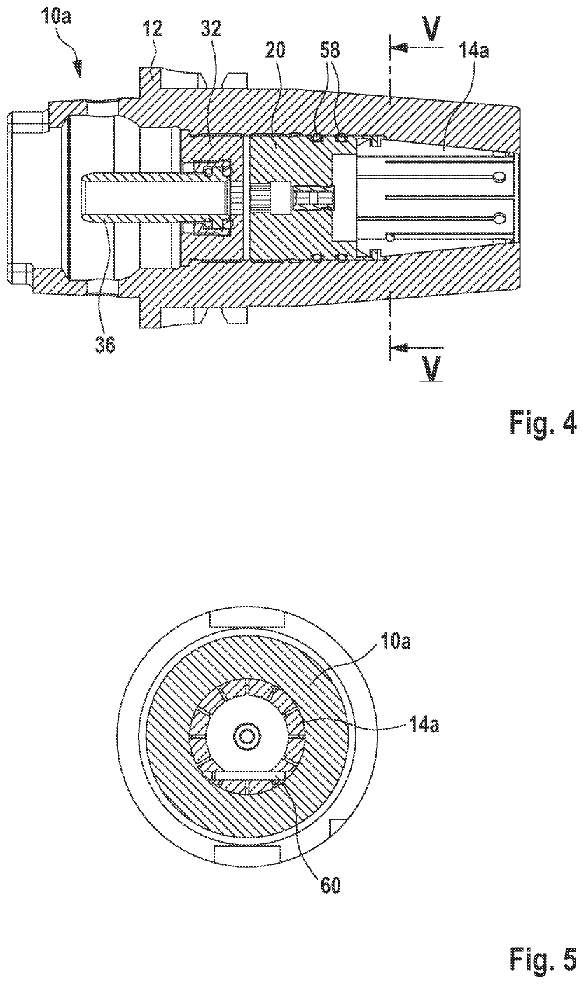

In FIGS. 4 and 5, a slightly modified version of the tool holder 10 as a whole is designated by numeral 10a, wherein the associated collet is designated by 14a. In other respects, corresponding reference numerals are used for corresponding parts.

FIG. 4 shows the combination of a collet 14a and a tool holder 10a in a longitudinal section, as shown in FIG. 2, respectively. In addition, annular elastomer elements 58 are provided between the tensioner 20 and the inner surface of the tool holder 14a, whereby damping of the system is achieved.

Furthermore, as can be seen from the sectional view according to FIG. 5, inside the collet 14a, a projection 60 is provided that is arranged as a pin extending in the transverse direction in the exemplary embodiment. The projection 60 can engage an associated surface of the tool shank (Weldon surface). In this way, a positive connection is formed between the tool shank and the collet 14a, so that the tool shank is reliably prevented from being pulled out of the collet 14a during operation. The positive connection formed in this way can only be released when the collet 14a is released.

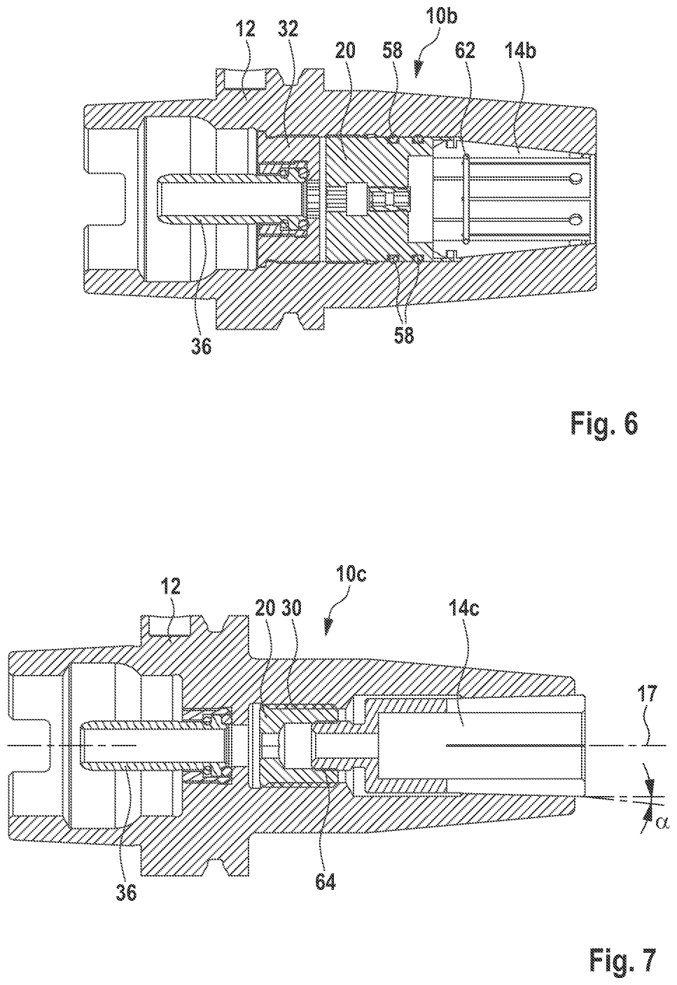

A further modification of the arrangement of the tool holder according to FIG. 4 is shown in FIG. 6 and designated by 10b. The associated collet is designated by 14b. In other respects, corresponding reference numerals are used for corresponding parts.

In contrast to the design shown in FIGS. 4 and 5, respectively, an axial form fit between the collet 14b and the tool shank is achieved by a bead 62 on the inner surface of the collet 14b. For this purpose, however, a correspondingly shaped groove must be provided on the tool shank.

The tensioner 20 can be made of a material with a considerably high density in order to shift the resonance frequency of the tool holder system in a targeted manner. For example, an alloy containing osmium and/or tungsten could be used for this purpose, resulting in a high density, at least in certain embodiments.

In FIG. 7, a further modification of the tool holder is designated as a whole by 10c, wherein the associated collet is designated by 14c. In other respects, corresponding reference numerals are used for corresponding parts.

In contrast to the versions of the tool holder shown in FIGS. 1 to 6, the cone angle α is negative in FIG. 7.

The collet 14c is provided with an attachment at the machine-side end, at which a threaded connection 64 with the tensioner 20 is provided. The tensioner 20 is in turn coupled to the tool holder 10c via a threaded connection 30. By using different pitches between the threaded connection 64 between the tensioner 20 and the collet 14c on the one hand and the threaded connection 30 between the tensioner and the tool holder 10c on the other hand, a differential thread can be realized in this way, by means of which a considerably sensitive adjustment can be achieved, at least in certain embodiments. The collet 14c is held non-rotatably on the tool holder 10c so that a rotation of the tensioner 20 is converted directly into an axial movement of the collet 14c.

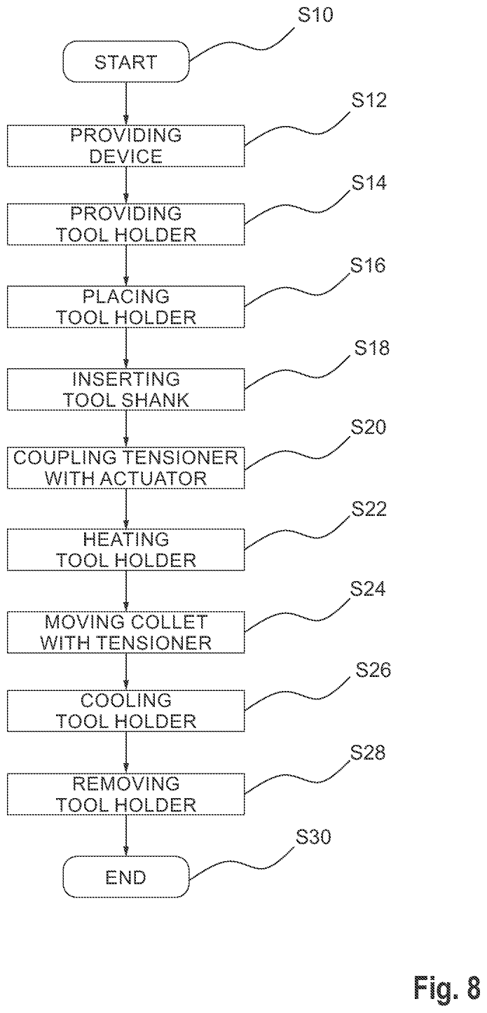

FIG. 8 illustrates, by means of a schematic block diagram, an exemplary embodiment of a method for clamping tools in a collet.

In the exemplary embodiment, the method starts at a step S10. In a step S12, a device in accordance with at least one embodiment of the present disclosure for clamping/unclamping tools in a collet a tool holder is provided. In a subsequent step S14, a tool holder that is to be equipped with a tool having a tool shank is provided. In certain embodiments, the tool holder is already provided with a collet and a tensioner in accordance with the present disclosure.

In a step S16, the tool holder is placed in the device. Prior to or after the step S16, the tool to be clamped is to be inserted into (the collet in) the tool holder, step S18. A step S20 relates to the coupling of the tensioner with an actuator of the device. In this way, the actuator is coupled to the collet of the tool holder. Step S20 may also be automatically performed when the tool is placed in the device in step S16. Coupling the tensioner with the actuator may involve engaging the tensioner via a rotary shaft of the actuator. Steps S12-S20 relate to the preparation of the actual clamping procedure.

Clamping takes place based on a combination of step S22, which involves heating the tool holder at least in the region where the collet is arranged, and step S24 which involves axially moving the collet within the tool holder by actuating the tensioner. Step S24 takes place after the tool holder is sufficiently expanded during the heating in step S22. In the step S24, with the tool holder thermally expanded, the actuation forces for moving the collet are relatively moderate. The resulting clamping force is achieved after a cooling step S26, in which the tool holder shrinks due to the cooling and thus urges the collet against the tool shank. Hence, also the cooling step S26 may be regarded as a part of the clamping procedure. The clamping force is based on a combination of the mechanical actuation force applied in step S24 and the shrink-fit force generated during the cooling step S26.

In a further step S28, the tool holder with the tool shank firmly clamped therein, can be removed from the device. In the illustrated embodiment, the method ends at step S30. The order of at least some of the steps of FIG. 8 is primarily for illustrative purposes, and not to be understood in a limiting sense. While the sequence illustrated in FIG. 8 relates to the clamping of a tool in a tool holder, the unclamping procedure may be rather similar, though some of the steps are to be processed in reversed/different order.

In order to loosen the tool shank, the tool holder has to be thermally expanded through heating in the device. Prior or parallel to the heating, the tensioner may be coupled with the collet to unclamp the tool shaft through an axial movement of the collet relative to the tool holder.

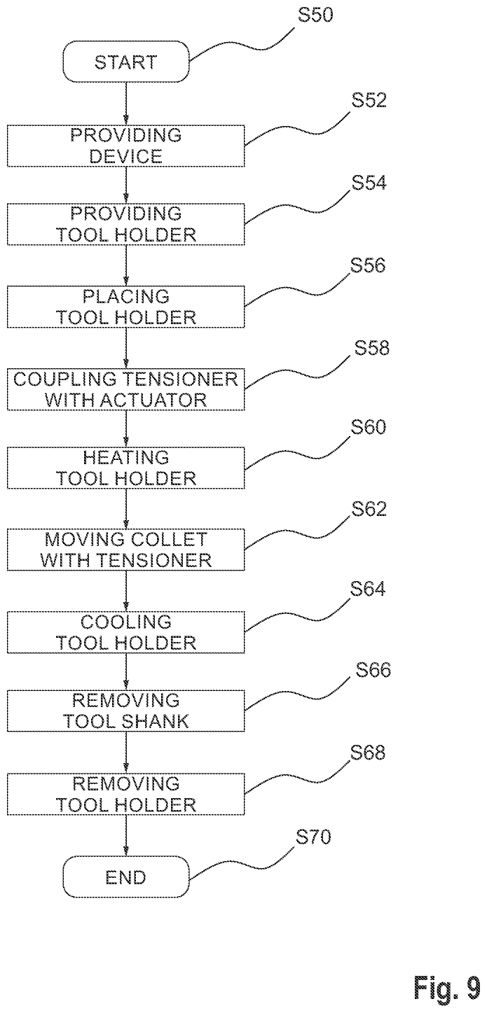

Clamping and unclamping can be performed with one and the same device. Hence, the device can be operated in a clamping mode and an unclamping mode. In this context, FIG. 9 illustrates, by means of a schematic block diagram, an exemplary embodiment of a method for unclamping tools from a collet.

In the exemplary embodiment, the method starts at a step S50. In a step S52, a device in accordance with at least one embodiment of the present disclosure for clamping/unclamping tools in a collet of a tool holder is provided. In subsequent step S54, a tool holder that is equipped with a tool having a tool shank is provided. The tool shank is firmly clamped in a collet arranged inside the tool holder. In certain embodiments, the tool holder is also provided with a tensioner formed in accordance with at least one embodiment of the present disclosure.

In a step S56, the tool holder is placed in the device. Parallel to or after the step S56, the tensioner is coupled with the actuator of the device, step S58. As the tool shank is firmly clamped, e.g., through the method illustrated in connection with FIG. 8, necessary unclamping forces cannot be achieved simply by mechanically actuating the tensioner to move the collet into an unclamped state.

Therefore, the unclamping procedure requires a heating of the tool holder in step S60 and, subsequently, in a thermally expanded state, an axial movement of the collet that is induced by an actuation of the tensioner in step S62. Due to the thermal expansion, the unclamping forces to be applied by the tensioner to the collet are rather moderate, in contrast to the huge clamping forces that can be achieved through a combination of shrink-fit clamping and frictional clamping. However, in certain embodiments, mechanical unclamping forces applied to the collet (step S62) are typically higher than mechanical clamping forces applied to the collet (step S24), in view of the friction between the conical surfaces of the collet and the tool holder that has to be surmounted for unclamping.

Once the collet with the tool shank held therein is loosened in step S62, the tool holder can be cooled in the step S64. In certain embodiments, it is possible to remove the tool shank from the tool holder in a step as S66 after the cooling step S64. The tool holder is no longer thermally expanded due to cooling. However, when the collet is moved by the tensioner into a losing position and held therein, shrinking of the tool shaft holder does not clamp the tool shank again in the collet. However, in certain embodiments, it is also possible to remove the tool with the tool shank from the tool holder prior to the cooling step S64. Hence, the order of at least some of the steps of FIG. 9 is primarily for illustrative purposes, and not to be understood in a limiting sense. In a subsequent step S68, the tool holder can be removed from the device. In the illustrated embodiment, the method ends at step S70.

What is claimed is:

1. A device for clamping and unclamping tools in a collet, comprising:
a tool holder having a machine side and a tool side that is configured to accommodate a tool shank of a tool,
a collet that is arranged for clamping the tool shank inside the collet, the collet having a conical outer surface, which rests against a correspondingly shaped inner surface of the tool holder, and
a movable tensioner that is configured to effect an axial movement of the collet with respect to the tool holder when the tool holder is thermally expanded, for clamping and unclamping the collet with the tool shank therein,
wherein the tensioner is arranged inside the tool holder on the machine side of the collet.

2. The device of claim 1, comprising
a heating unit for heating the tool holder in the region of the collet.

3. The device of claim 2,
wherein the heating unit is arranged as an inductive heating unit having an induction coil, and
wherein the induction coil is arranged to be positioned concentrically to the tool holder in the region of the collet for heating the tool holder in the region of the collet.

4. The device of claim 1, comprising:
an actuator that is arranged as a rotary drive that is configured to rotate the tensioner,
wherein a threaded connection is provided between the tensioner and the tool holder for converting a rotary movement of the actuator into an axial movement of the tensioner with respect to the tool holder.

5. The device of claim 4,
wherein the actuator is coupled to the tensioner via a rotary shaft that is configured to engage the tensioner through a machine side of the tool holder.

6. The device of claim 1,
wherein an axial form fit is provided between the tensioner and the collet that effects the axial movement of the collet when the tensioner is axially moved.

7. The device of claim 1,
wherein a threaded connection is formed between the tensioner and the collet that effects the axial movement of the collet when the tensioner is rotated.

8. The device of claim 7,
wherein the collet is held non-rotatably in the tool holder,
wherein a threaded connection is formed between the tensioner and the tool holder, and
wherein the threaded connection between the tensioner and the tool holder and the threaded connection between the tensioner and the collet have different pitches to form a differential thread.

9. The device of claim 1, comprising:
a holder that is arranged to receive the tool holder in a rotationally fixed manner.

10. The device of claim 1, comprising:
a control unit that is configured to coordinate the heating of the tool holder and the collet with the movement of the tensioner and the collet for clamping or unclamping the tool in the collet.

11. The device of claim 1,
wherein a coefficient of static friction between the tool holder and the collet is lower than a coefficient of static friction between the collet and the tool shank.

12. The device of claim 1,
wherein the collet is held interchangeably inside the tool holder.

13. The device of claim 1,
wherein a central coolant supply is provided through the machine side of the tool holder via the tensioner into the collet.

14. The device of claim 1,
wherein a projection projecting towards the tool shank is formed inside the collet, which enables an axial form fit with the tool shank in a clamped state of the tool shank, and
wherein the tool shank is releasable from the projection only when the collet is in a released state.

15. The device of claim 1,
wherein the tensioner is axially guided within the tool holder and comprises a clamping surface facing the collet, which cooperates with a corresponding surface of the collet facing the tensioner to clamp the collet.

16. A device for clamping tools in a collet of a tool holder, comprising:
a holder having a flange that is configured to accommodate a machine-side section of a tool holder,
a heating unit for heating the tool holder in a region where a collet is accommodated in the interior of the tool holder, and
an actuator that is configured to operate a tensioner inside the tool holder that is coupled to the collet to axially move the collet within the tool holder, when the tool holder is thermally expanded through heating with the heating unit.

17. The device as claimed in claim 16, comprising:
a control unit that is operatively coupled to the heating unit and the actuator,
wherein the control unit is configured to coordinate the heating of the tool holder with an movement of the tensioner relative to the collet for clamping or unclamping tools,
wherein, for a clamping action, the collet is axially moved in a first direction into a clamped state to clamp a tool shaft when the tool holder is thermally expanded, and
wherein, for an unclamping action, the collet is moved in a second direction that is opposite to the first direction into a loosening state when the tool holder is thermally expanded.

18. A tool holder for a tool having a tool shank, the tool holder comprising:
a machine-side portion having a tapered mounting shaft,
a tool-side portion that is configured to accommodate a tool shank of a tool,
an outer flange between the machine-side portion and the tool-side portion,
a collet arranged in the tool-side portion,
wherein the collet has a conical outer surface, which is adapted to a correspondingly shaped inner surface of the tool holder, and
wherein the collet is configured to accommodate and clamp the tool shank inside the collet upon a thermal expansion of the tool-side portion of the tool holder that is coordinated with an axial movement of the collet inside the thermally expanded tool-side portion, and
a tensioner that is movably arranged in the tool holder and operatively coupled with the collet to effect the axial movement of the collet with respect to the tool holder.

19. The tool holder as claimed in claim 18,
wherein in a clamped state with the collet nested in the tool-side portion of the tool holder and the tool shank nested in the collet, an increased effective clamping force is present due to a combination of the axial movement of the collet in an expanded state of the tool-side portion of the tool holder and a shrinking of the tool-side portion of the tool holder.

20. A method for clamping or unclamping tools in a collet of a tool holder, the method comprising the following steps:
providing a collet that has a machine side and a tool side, and having inserted therein a collet, the collet having a conical outer surface in a correspondingly shaped cavity of the tool holder;
coupling the collet with a tensioner for clamping or unclamping the collet,
wherein the tensioner is movable within the tool holder, and
wherein the tensioner is coupled the collet on a machine side of the collet;
inserting a tool with a tool shank into a cavity that is formed by the collet;
heating the tool holder in the region of the collet; and
while the tool holder is thermally expanded due to the heating, moving the tensioner for clamping the collet with the tool shank therein or for unclamping the collet and the tool shank.
